(19) United States
(12) Patent Application Publication
(10) Pub. No.: US 2011/0215547 A1
(43) Pub. Date: Sep. 8, 2011

(54) ERGONOMICAL MULTI-SPEED WHEELCHAIR

(76) Inventor: Ewin Jesse Davenport, Renton, WA (US)

(21) Appl. No.: 12/673,964

(22) PCT Filed: Aug. 22, 2008
(86) PCT No.: PCT/US2008/074038

§ 371 Date: Feb. 17, 2010

Related U.S. Application Data
(60) Provisional application No. 60/967,784, filed on Sep. 7, 2007.

(51) Int. Cl. A61G 5/02; A61G 5/00; F16H 27/02

(52) U.S. Cl. 280/250.1; 280/263; 74/89.2

(57) ABSTRACT

This invention relates generally to mechanics, and more specifically, to systems and methods for providing an ergonomical multi-speed wheelchair. In one embodiment, the invention includes a vehicle for providing ergonomical operation, the vehicle including a frame, the frame having a rear wheel and a front wheel, the rear wheel being rotationally coupled to the frame via a rear wheel shaft, the frame including a drive linkage pulley; a drive bar, the drive bar being slidably mounted to the frame; a slotted reel, the slotted reel mounted on the rear wheel shaft; and a drive linkage, the drive linkage mounted to the drive bar, the drive linkage looping over the drive linkage pulley before being coupled to the slotted reel, wherein sliding the drive bar towards the drive linkage pulley results in the drive linkage coiling around the slotted reel, wherein sliding the drive bar away from the drive linkage pulley results in the drive linkage uncoiling from the slotted reel, and wherein uncoiling of the drive linkage operates to rotate the rear wheel shaft and the rear wheel to propel the frame.

### PRIORITY CLAIM

This application claims the benefit of U.S. Provisional Application No. 60/967,784 filed Sep. 7, 2007 (our ref. DVPT-1-1001). The foregoing application is incorporated by reference in its entirety as if fully set forth herein.

### FIELD OF THE INVENTION

This invention relates generally to mechanics, and more specifically, to systems and methods for providing an ergonomical multi-speed wheelchair.

### BACKGROUND

Traditional wheelchairs are operated by manually rotating the rear wheels using handrims. Movement in a straight line is accomplished by simultaneously rotating both handrims, while turning is accomplished by rotating one of the handrims more than the other. Such operation suffers from a number of notable deficiencies. First, use of the handrims requires an operator to repeatedly embrace and release the handrims in order to effectuate desired movement. Years of this unnatural and uncomfortable motion is detrimental to the health of an operator's hands and joints. Second, rotation of the wheels requires an operator to repeatedly move his hands, arms, and shoulders in short bursts along the curved path defined by the wheel. Not only is this curved motion damaging to the operator's hand, elbow, and shoulder joints, the motion relies on an operator's relatively weak arm muscles. Third, the speed of traditional wheelchairs is limited by the operator's ability to rotate the rear wheels. The faster an operator desires to travel, the faster the operator must awkwardly embrace, rotate, and release the handrims.

Thus, although desirable results have been achieved, there exists much room for improvement. What is needed then are systems and methods for providing an ergonomical multi-speed wheelchair.

### SUMMARY

This invention relates generally to mechanics, and more specifically, to systems and methods for providing an ergonomical multi-speed wheelchair. In one embodiment, the invention includes a vehicle for providing ergonomical operation, the vehicle including a frame, the frame having a rear wheel and a front wheel, the rear wheel being rotationally coupled to the frame via a rear wheel shaft, the frame including a drive linkage pulley; a drive bar, the drive bar being slidably mounted to the frame; a slotted reel, the slotted reel mounted on the rear wheel shaft; and a drive linkage, the drive linkage mounted to the drive bar, the drive linkage looping over the drive linkage pulley before being coupled to the slotted reel, wherein sliding the drive bar towards the drive linkage pulley results in the drive linkage coiling around the slotted reel, wherein sliding the drive bar away from the drive linkage pulley results in the drive linkage uncoiling from the slotted reel, and wherein uncoiling of the drive linkage operates to rotate the rear wheel shaft and the rear wheel to propel the frame.

### BRIEF DESCRIPTION OF THE DRAWINGS

Embodiments of the present invention are described in detail below with reference to the following drawings:

FIG. 1 is a perspective view of an ergonomical multi-speed wheelchair, in accordance with an embodiment of the invention;

FIG. 2 is a side elevational view of an ergonomical multi-speed wheelchair, in accordance with an embodiment of the invention;

FIG. 3 is a partial rear elevational view of an ergonomical multi-speed wheelchair, in accordance with an embodiment of the invention;

FIG. 4 is a rear elevational view of a gear system of an ergonomical multi-speed wheelchair, in accordance with an embodiment of the invention;

FIG. 5 is a partially exposed rear elevational view of a gear system of an ergonomical multi-speed wheelchair, in accordance with an embodiment of the invention;

FIG. 6 is a side elevational view of a dual mode front wheel system of an ergonomical multi-speed wheelchair, in accordance with an embodiment of the invention;

FIG. 7 is a perspective view of a dual mode front wheel system of an ergonomical multi-speed wheelchair, in accordance with an embodiment of the invention; and

FIG. 8 is a perspective view of a handle steering system of an ergonomical multi-speed wheelchair, in accordance with an embodiment of the invention.

### DETAILED DESCRIPTION

This invention relates generally to mechanics, and more specifically, to systems and methods for providing an ergonomical multi-speed wheelchair. Specific details of certain embodiments of the invention are set forth in the following description and in

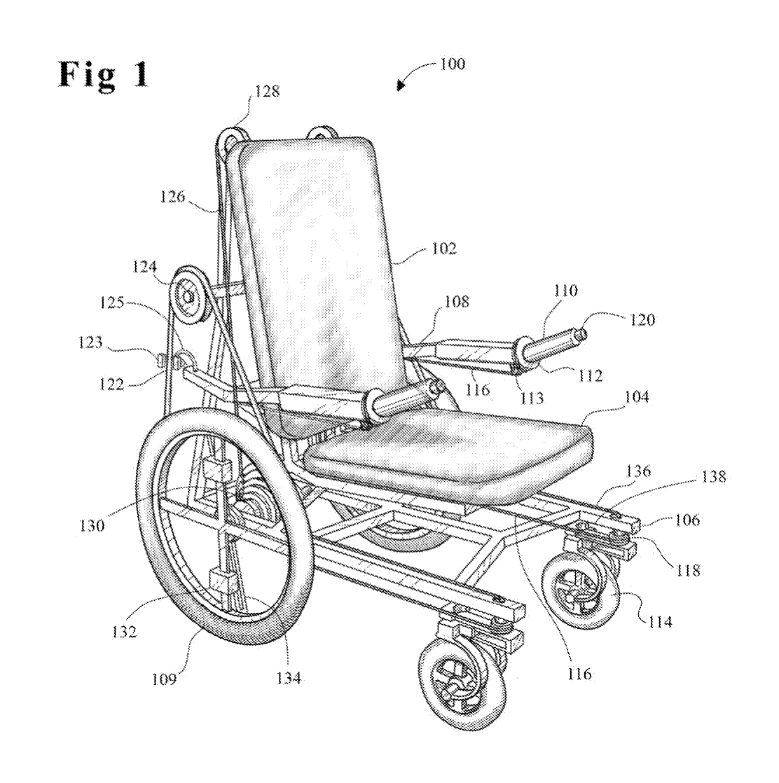

FIGS. 1-8 to provide a thorough understanding of such embodiments. The present invention may have additional embodiments, may be practiced without one or more of the details described for any particular described embodiment, or may have any detail described for one particular embodiment practiced with any other detail described for another embodiment.

The term linkage as used herein is intended to mean a cable, rope, belt, string, chain, rod, or some other similar device. The term ‘wheelchair’ as used herein is intended to mean any vehicle that has at least one wheel.

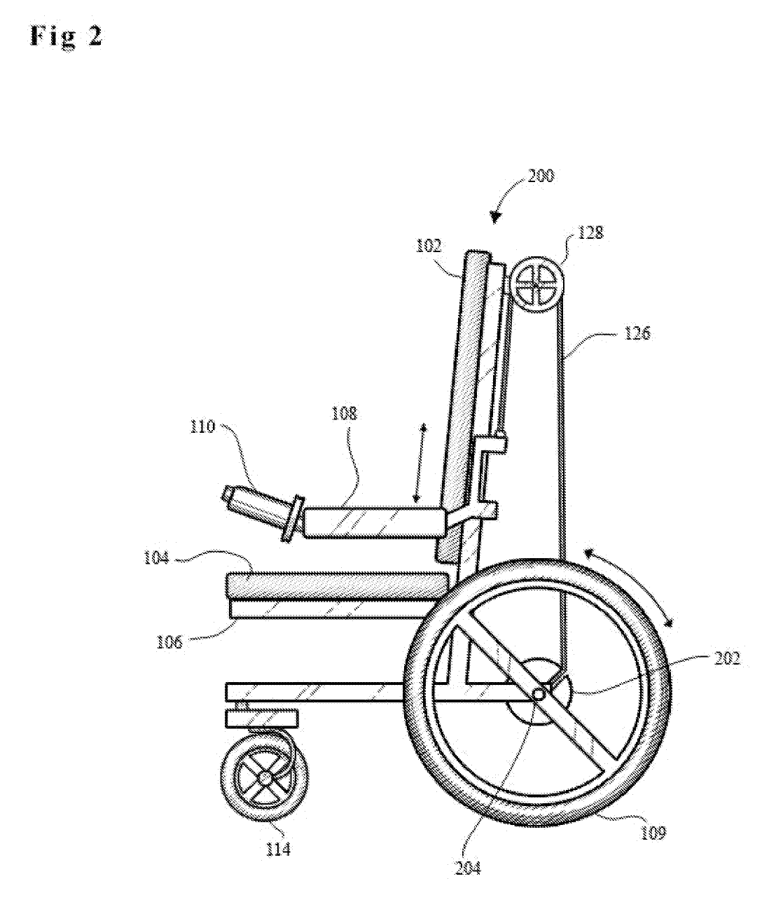

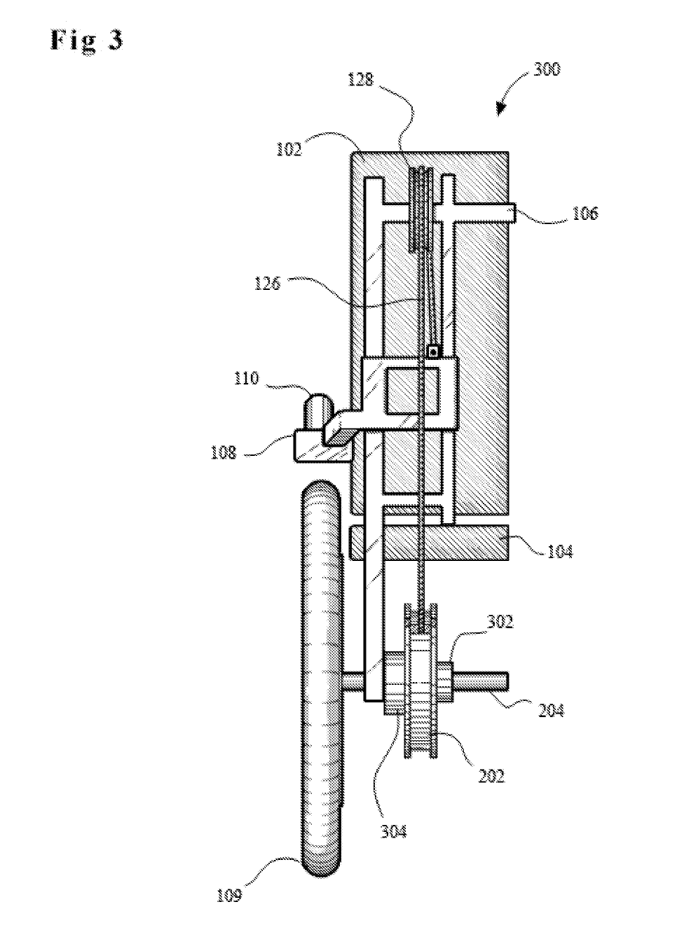

FIG. 1 is a perspective view of an ergonomical multi-speed wheelchair, in accordance with an embodiment of the invention. In one embodiment, system 100 includes a seat back 102, a seat bottom 104, a frame 106, a drive bar 108, a rear wheel 109, a handle 110, a handle pulley 112, a drive bar steering linkage pulley 113, a front wheel 114, a steering linkage 116, a front wheel steering linkage pulley 118, a brake 120, a speed regulating linkage 122, a brake clasp 123, a speed regulating linkage pulley 124, a brake linkage 125, a drive linkage 126, a drive linkage pulley 128, a slotted step reel set 130, a centrifugal weight 132, a centrifugal weight guide arm 134, a caster linkage 136, and a steering block 138. The seat back 102 and the seat bottom 104 are disposed on the frame 106 in such a manner as to facilitate a person sitting thereon. The rear wheel 109 and the front wheel 114 are rotatably mounted to the frame 106 with an opposing rear wheel and front wheel (not labeled) also being rotatably mounted to the frame 106. The drive bar 108 is slidably mounted at the rear of the frame 106 behind the seat back 102 and extends laterally around both sides of the seat back 102 and forwardly, whereby the drive bar 108 is positioned proximate to the arms of a person who sits on the seat bottom 104. The handle 110 rotatable extends from one end of the drive bar 108 with an opposing handle (not labeled) rotatably extending from the other end of the drive bar 108. The handle 110 includes the handle pulley 112 at its base and the brake 120 at its tip. At its rear, the drive bar 108 is coupled to the drive linkage 126 (FIGS. 2, 3) and the drive linkage 126 loops over the drive linkage pulley 128, which is disposed at the top of the frame 106 behind the seat back 102, before connecting to the slotted step reel set 130, which is disposed at the bottom of the frame 106 adjacent to the rear wheel 109. Another drive linkage (not labeled) is similarly disposed to interact with the opposing rear wheel (not labeled). The drive bar 108 is then configurable to slide up and down along the frame 106 behind the seat back 102. The slotted step reel set 130 is rotationally coupled to a shaft (not visible) that connects to the rear wheel 109. The rear wheel 109 includes a centrifugal weight 132, which is slidably 100 mounted to the hub of the rear wheel 109. Another centrifugal weight (not labeled) is oppositely disposed on the hub of the rear wheel 109. The centrifugal weight guide arm 134 rotationally traverses the diameter of the rear wheel 109 and is configurable to ensure that the opposing centrifugal weights on the rear wheel 109 remain equidistant from one another. Accordingly, linear motion from the drive bar 108 is converted to rotational motion of the 105 slotted step reel set 130 through the drive linkage 126, which rotational motion rotates the rear wheel 109 and propels the frame 106 forward. The speed regulating linkage 122 circumscribes the rear wheel 109 and the speed regulating linkage pulley 124, which is rotatably coupled to the frame 106. The speed regulating linkage 122 rotates about the rear wheel 109 and the speed regulating linkage pulley 124 as the rear wheel 109 is rotated and 110 the frame 106 is propelled forward. The brake 120 is coupled to a brake linkage 125 which operates the brake clasp 123. The brake clasp 123 is disposed proximate to the speed regulating linkage 122 and is configurable to compress against the speed regulating linkage 122 upon application of the brake 120. Compression of the brake clasp 123 against the speed regulating linkage 122 induces friction and slows the speed regulating linkage 122 and the 115 rear wheel 109 to reduce the speed of the frame 106. Additionally, compression of the brake clasp 123 against the speed regulating linkage 122 is configurable to retain the speed regulating linkage 122 for rotating the frame or moving the frame rearwardly. The front wheel 114 is rotatably coupled to the frame 106 through the front wheel steering linkage pulley 118, which is itself rotatable relative to the front wheel 114 and the frame 106. The 120 front wheel 114 includes the steering block 138 which is movable between a disengaged position (as illustrated) and an engaged position relative to the front wheel steering linkage pulley 118 using the caster linkage 136. When the steering block 138 is disengaged from the front wheel steering linkage pulley 118, the front wheel 114 is configurable to caster relative to the frame 106. Oppositely, when the steering block 138 is engaged with the steering 125 linkage pulley 118 using the caster linkage 136, the front wheel 114 is controllably rotatable by applying force to the front wheel steering linkage pulley 118. Force is applied to the front wheel steering linkage pulley 118 by using the steering linkage 116 which extends from the front wheel steering linkage pulley 118 to the handle 110. At the handle 110, the steering linkage 116 loops around the drive bar steering linkage pulley 113 and the handle pulley 112 130 such that rotational motion of the handle 110 is transferred into rotational motion of the front wheel steering linkage pulley 118 through the steering linkage 116.

In various other embodiments, system 100 includes only a single rear wheel 109 or a single front wheel 114. Accordingly, system 100 can be a one, two, three, or more wheeled device. When system 100 includes only two wheels, a set of training or parking 135 wheels is optionally usable. In further embodiments, any of the components of system 100 have an opposing component or do not have an opposing component. In one particular embodiment, the drive bar 108 is shorter, longer, or differently shaped. For instance, the drive bar 108 can loop around and couple with the opposing drive bar. In yet another particular embodiment, the handle 110 is fixedly mounted to the drive bar 108 and the 140 steering mechanism is omitted, supplemented or alternatively achieved, such as by moving the drive bars 108 laterally. In an alternative embodiment, the brake 120 is omitted, supplemented, or alternatively achieved, such as by using a handle grip or pushing or pulling the handle 110. In an additional embodiment, the speed regulating linkage 122 is omitted, supplemented, or the speed regulation is alternatively achieved such as using disk brakes. In 145 a further embodiment, the drive bar 108 is configured to alternatively move such as horizontally, laterally, or rotationally. In one embodiment, the drive linkage 126 loops around a plurality of pulleys before connecting with the slotted step reel set 130. In another particular embodiment, the slotted step reel set 130 includes only a single slotted reel or is substituted with a sprocket. In an additional embodiment, the centrifugal weight 132 or the 150 centrifugal weight guide arm 134 is omitted, supplemented, or the gear shifting is alternatively achieved. In one particular embodiment, the centrifugal weight 132 or the centrifugal weight guide arm are separated from the wheel 109. In a further embodiment, the wheel 109 includes a suspension system. In yet a further embodiment, the steering block 138 is fixed with the front wheel steering linkage pulley 118. In an alternative embodiment, the 155 seat bottom 104 or the seat back 102 tilts for or during steering. In an additional embodiment, the rear wheel 109 is steerable. In an alternative embodiment, any of the components are encased in a protective housing.

FIG. 2 is a side elevational view of an ergonomical multi-speed wheelchair, in accordance with an embodiment of the invention. In one embodiment, system 160 200 includes the seat back 102, the seat bottom 104, the frame 106, the drive bar 108, the rear wheel 109, the handle 110, the front wheel 114, the drive linkage 126, the drive linkage pulley 128, a slotted reel 202, and a rear wheel shaft 204. The seat back 102 and the seat bottom 104 are disposed on the frame 106 in such a manner to facilitate a person sitting thereon. The front wheel 114 is rotatably mounted to the front of the frame 106 and the drive 165 linkage pulley 128 is rotatably mounted to the top of the frame 106 behind the seat back 102.

The rear wheel 109 and the slotted reel 202 are rotatably coupled through the rear wheel shaft 204, which supports the frame 106. The drive bar 108 is slidably mounted to the frame 106 behind the seat back 102 and extends around and forward from the seat back 102. The handle 110 is mounted to the end of the drive bar 108. The drive linkage 126 is coupled to 170 the drive bar 108 and loops over the drive linkage pulley 128 before connecting to the slotted reel 202. The slotted reel 202 includes a tension bias device 304 and is rotatably coupled to the rear wheel shaft 204 through a clutch 302 (FIG. 3). The clutch 302 permits clockwise rotation of the slotted reel 202 without resistance, but counter-clockwise rotation of the slotted reel 202 rotates the rear wheel shaft 204 and therefore the rear wheel 109. The 175 tension bias device 304 biases the slotted reel 202 in a clockwise rotational direction. Thus, when the drive bar 108 is slidably moved up the frame 106, the excess drive linkage 126 is coiled about the slotted reel 202 as the tension bias device 304 biases the slotted reel 202 in a clockwise direction. Oppositely, when the drive bar 108 is slidably moved down the frame 106, the drive linkage 126 is pulled and uncoiled from the slotted reel 202 thereby forcing the 180 slotted reel 202 to rotate in a counter-clockwise direction. The counter-clockwise rotation of the slotted reel 202 rotates the rear wheel shaft 204 and the rear wheel 109 and propels the frame 106 forward. The clutch permits the rear wheel 109 to continue rotating when the slotted reel 202 rests upon the drive linkage 126 being uncoiled. However, the drive bar 108 can again be slidably moved up the frame 106 to repeat the process and further propel the 185 frame 106 forward.

In additional embodiments, the seat bottom 104 or the seat back 102 are differently positioned or mechanically or electromechanically adjustable. In various other embodiments, the drive bar 108 is configurable to move horizontally, vertically, rotationally, laterally, or a combination of the same. In a further embodiment, the drive bar 108 is shorter, 190 longer, more tilted, less tilted, or adjustable. In one embodiment, the drive bar 108 is differently mounted to the frame 106, such as on a side of the frame 106 or below the seat bottom 104. In an additional embodiment, the drive bar 108 is coupled to a drive linkage for converting upward motion of the drive bar 108 into rotational motion of the rear wheel 109. In this embodiment, another slotted reel is reversibly disposed on the rear wheel shaft 204. 195 In yet a further embodiment, the drive bar 108 is coupled to a drive linkage for converting motion of the drive bar 108 into rotational motion of the front wheel 114. In a further embodiment, the rear wheel 109 includes a rim or other device for manually turning the wheel.

FIG. 3 is a partial rear elevational view of an ergonomical multi-speed 200 wheelchair, in accordance with an embodiment of the invention. In one embodiment, system 300 includes the seat back 102, the seat bottom 104, the frame 106, the drive bar 108, the rear wheel 109, the handle 110, the drive linkage 126, the drive linkage pulley 128, the slotted reel 202, the rear wheel shaft 204, the clutch 302, and the tension bias device 304. The drive bar 108 is slidably mounted to the frame 106 and is configurable to move up the frame 106 205 towards the drive linkage pulley 128 and down the frame 106 away from the drive linkage pulley 128. The drive linkage 126 is coupled to the drive bar 108 and loops around the drive linkage pulley 128 before connecting to the slotted reel 202. As the drive bar 108 is moved up the frame 106 towards the drive linkage pulley 128, the excess drive linkage 126 is coiled around the slotted reel 202 as the tension bias device 304 winds up the slotted reel 202. 210 When the drive bar 108 is moved down the frame 106 away from the drive linkage pulley 128, the drive linkage 126 is pulled and uncoiled from the slotted reel 202 thereby forcing rotation of the rear wheel shaft 204 and the rear wheel 109 and propelling the frame 106 forward. The drive bar 108 can again be slidably moved up the frame 106 to repeat the process and further propel the frame 106 forward.

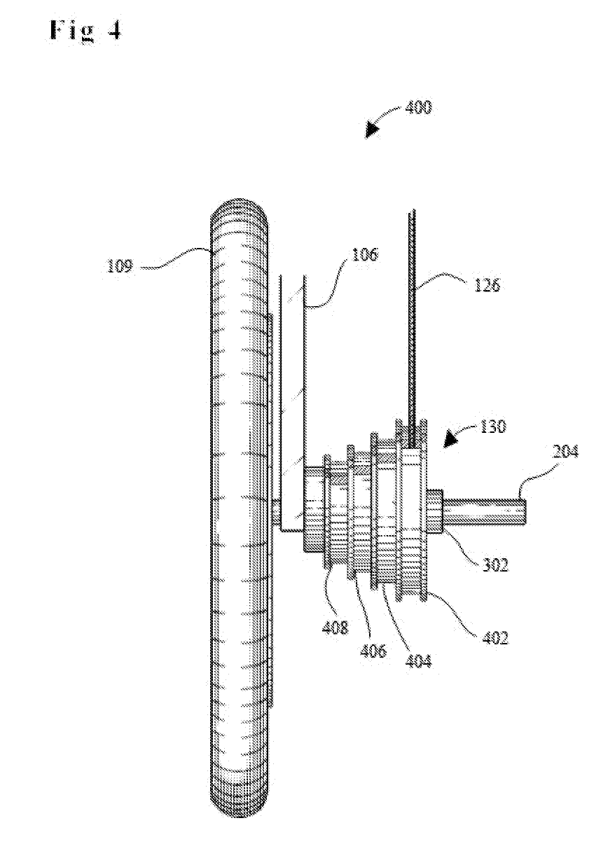

FIG. 4 is a rear elevational view of a gear system of an ergonomical multi-speed wheelchair, in accordance with an embodiment of the invention. In one embodiment system 400 includes the frame 106, the rear wheel 109, the drive linkage 126, the slotted step reel set 130, the rear wheel shaft 204, the clutch 302, and the tension bias device 304. The slotted step reel set 130 includes slotted reel 402, slotted reel 404, slotted 220 reel 406, and slotted reel 408. The drive linkage 126 is coupled to the drive bar 108 and loops around the drive linkage pulley 128 before connecting to the slotted step reel set 130 (FIG. 1). When the rear wheel 109 is at a resting position, the drive linkage 126 is connected to the slotted step reel set 130 at the slotted reel 402. As the drive bar 108 is moved up the frame 106 towards the drive linkage pulley 128, the excess drive linkage 126 is 225 coiled around the slotted reel 402 as the tension bias device 304 winds up the slotted step reel set 130. When the drive bar 108 is moved down the frame 106 away from the drive linkage pulley 128, the drive linkage 126 is pulled and uncoiled from the slotted reel 402 thereby forcing rotation of the rear wheel shaft 204 and the rear wheel 109 and propelling the frame 106 forward. In certain embodiments, the slotted reel 402 is fixed to the rear wheel shaft 204 230 and a clutch interfaces the rear wheel shaft 204 with the rear wheel 109. In other embodiments, the slotted reel 402 interfaces with the rear wheel shaft 204 through a clutch. As the rear wheel 109 increases its speed, the drive linkage 126 is slidable to the slotted reel 404 to provide a higher gear. Thus, as the drive bar 108 is moved up the frame 106 towards the drive linkage pulley 128, the excess drive linkage 126 is coiled around the slotted reel 235 404 as the tension bias device 304 winds up the slotted step reel set 130. When the drive bar 108 is moved down the frame 106 away from the drive linkage pulley 128, the drive linkage 126 is pulled and uncoiled from the slotted reel 404 thereby forcing even faster rotation of the rear wheel shaft 204 and the rear wheel 109 and further propelling the frame 106 forward at a faster speed. Again, as the rear wheel 109 increases its speed, the drive linkage 126 is 240 slidable further to the slotted reel 406 or even 408 to provide even higher gears. Oppositely, as the rear wheel 109 decreases its speed, the drive linkage 126 is slidable back towards the slotted reel 402 to a lower gear.

In other embodiments, the slotted step reel set 130 has fewer or greater slotted reels. In a further embodiment, the slotted step reel set 130 is complimented with one 245 or more additional slotted step reel sets, such as one for providing rotational force during the upward motion of the drive bar 108. In a further embodiment, any of the slotted reels of the slotted step reel set 130 is defined by a different shape, such as an oval or any other uniform or non-uniform shape to facilitate an ergonomical stroke of the drive bar 108.

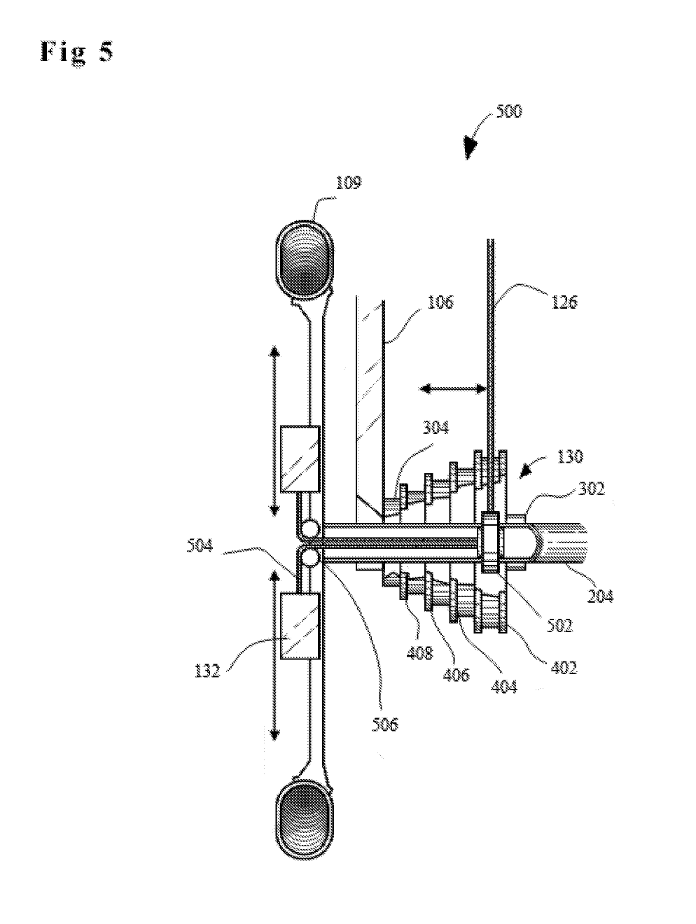

FIG. 5 is a partially exposed rear elevational view of a gear system of 250 an ergonomical multi-speed wheelchair, in accordance with an embodiment of the invention. In one embodiment, system 500 includes the frame 106, the rear wheel 109, the drive linkage 126, the slotted step reel set 130, the centrifugal weight 132, the rear wheel shaft 204, the clutch 302, the tension biasing device 304, the rotational magnet 502, the centrifugal linkage 504, and the centrifugal linkage pulley 506. The slotted step reel set 130 includes the slotted 255 reel 402, the slotted reel 404, the slotted reel 406, and the slotted reel 408. The centrifugal weight 132 is slidably mounted on the hub of the rear wheel 109. The centrifugal linkage 504 is coupled to the centrifugal weight 132 and bends over the centrifugal linkage pulley 506 before extending through the rear wheel shaft 204 and the slotted step reel set 130. Another centrifugal weight (not labeled) is oppositely disposed with another centrifugal 260 linkage (not labeled) extending therefrom and bending over another centrifugal linkage pulley (not labeled) to within the rear wheel shaft 204 and the slotted step reel set 130. The drive linkage 126 extends from the drive linkage pulley 128 (FIG. 1) to within the interior of the slotted step reel set 130. The centrifugal linkage 504 and the drive linkage 126 magnetically interact via the rotational magnets 502 such that the centrifugal linkage 504 is 265 rotatable without resistance relative to the drive linkage 126. However, the centrifugal linkage 504 and the drive linkage 126 also magnetically interact via the rotational magnets 502 such that the drive linkage 126 traces the lateral movement of the centrifugal linkage 504 between the slotted reels of the slotted step reel set 130. In one particular embodiment, the rotational magnet 502 coupled to the drive linkage 126 is slidably mounted on a track within 270 the slotted step reel set 130, which facilitates the drive linkage 126 tracing the lateral movement of the centrifugal linkage 504. The centrifugal linkage 504 is tension biased such that the rotational magnets 502 are disposed at a position parallel with the slotted reel 402 whereby the drive linkage 126 extends therefrom. Accordingly, when the rear wheel 109 is at a resting position, the drive linkage 126 is connected to the slotted step reel set 130 at the 275 slotted reel 402 or another slotted reel. As the drive bar 108 is moved up the frame 106 towards the drive linkage pulley 128, the excess drive linkage 126 is coiled around the slotted reel 402 as the tension bias device 304 winds up the slotted step reel set 130 (FIG. 1). When the drive bar 108 is moved down the frame 106 away from the drive linkage pulley 128, the drive linkage 126 is pulled and uncoiled from the slotted reel 402 thereby forcing 280 rotation of the rear wheel shaft 204 and the rear wheel 109 and propelling the frame 106 forward. As the rear wheel 109 increases its speed, the centrifugal weight 132 submits to centrifugal force and pulls the centrifugal linkage 504 from the rear wheel shaft 204 against the tension bias. Lateral movement of the centrifugal linkage 504 pulls the rotational magnets 502 and causes the drive linkage 126 to trace the rotational magnets 502 and slide to 285 the next slotted reel, in this case the slotted reel 404. Thus, as the drive bar 108 is moved up the frame 106 towards the drive linkage pulley 128, the excess drive linkage 126 is coiled around the slotted reel 404 as the tension bias device 304 winds up the slotted step reel set 130. When the drive bar 108 is moved down the frame 106 away from the drive linkage pulley 128, the drive linkage 126 is pulled and uncoiled from the slotted reel 404 thereby 290 forcing even faster rotation of the rear wheel shaft 204 and the rear wheel 109 and further propelling the frame 106 forward at a faster speed. As the rear wheel 109 increases its speed, the centrifugal weight 132 again submits to centrifugal force and pulls the centrifugal linkage 504 further from the rear wheel shaft 204. Lateral movement of the centrifugal linkage 504 pulls the rotational magnets 502 and causes the drive linkage 126 to trace the rotational 295 magnets 502 and slide to the next slotted reel, in this case the slotted reel 406 or even 408 to provide even higher gears. In one particular embodiment, the drive bar 108 includes a rearwardly disposed extension member that is configurable to contact the slotted step reel set 130 to assist in rotating the slotted step reel set 130 to facilitate the drive linkage 126 sliding to the next slotted reel. Oppositely, as the rear wheel 109 decreases its speed, the centrifugal 300 weight 132 slides centrally and releases the centrifugal linkage 504 to within the rear wheel shaft 204 thereby causing the drive linkage 126 to trace the rotational magnets 502 and slide back towards the slotted reel 402 to a lower gear.

In certain embodiments, fewer or greater centrifugal weights 132 are disposed on the hub of the rear wheel 109. In an alternative embodiment, the centrifugal 305 weight 132 is differently mounted on the rear wheel 109 or on the rear wheel shaft 204, such as on a mechanism that operates by centrifugal force. In one particular embodiment, the centrifugal weight guide arm 134 is rotationally movable about the rear wheel shaft 204 (FIG. 1). The centrifugal weight 132 and the opposing centrifugal weight each include a guide pin that is inserted within the centrifugal weight guide arm 134. The centrifugal 310 weight guide arm 134 operates in coordination with the guide pins to ensure that the centrifugal weight 132 and the opposing centrifugal weight remain approximately equidistant to the center of the rear wheel 109. In a further particular embodiment, the centrifugal weight 132 and the centrifugal linkage 504 are omitted, supplemented, or replaced with an alternative mechanism for shifting gears such as manually or mechanically guided movement 315 of the drive linkage 126. In one particular embodiment, the drive linkage 126 is frictionally or magnetically centered parallel to a particular slotted reel.

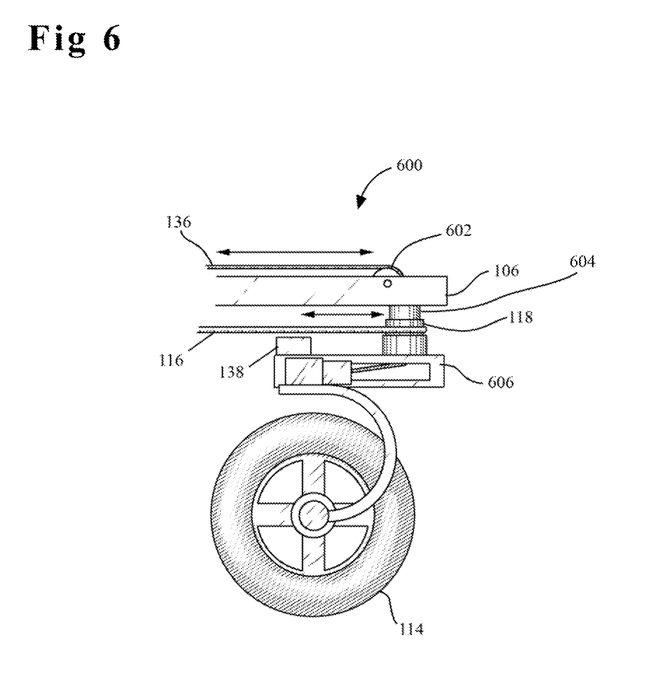

FIG. 6 is a side elevational view of a dual mode front wheel system of an ergonomical multi-speed wheelchair, in accordance with an embodiment of the invention. In one embodiment, system 600 includes the frame 106, the front wheel 114, the steering 320 linkage 116, the front wheel steering linkage pulley 118, the caster linkage 136, the steering block 138, a caster linkage pulley 602, a front wheel shaft 604, and a steering block track 606. The front wheel is coupled to the steering block 138, which is slidable along the length of the steering block track 606. The front wheel shaft 604 extends from the steering block track 606 and extends through the frame 106. The caster linkage 136 extends from a control 325 device (not illustrated) and bends over the caster linkage pulley 602 before extending through the frame 106 and the front wheel shaft 604. The caster linkage 136 then exits the front wheel shaft 604 and couples to the steering block 138. The front wheel steering linkage pulley 118 is movably mounted on the front wheel shaft 604 and is configurable to removably receive the steering block 138. In one particular embodiment, the front wheel 330 steering linkage pulley 118 and the steering block 138 are magnetized. The steering linkage 116 extends from the handle pulley 112 (FIG. 1) and loops around the front wheel steering linkage pulley 118. The steering block 138 is tension biased to an end of the steering block track 606 distal from the front wheel steering linkage pulley 118. However, pulling of the caster linkage 136 against the tension bias slidably displaces the steering block 335 138 towards the front wheel steering linkage pulley 118 whereby the steering block 138 engages the front wheel steering linkage pulley 118. Accordingly, the front wheel 114 is configurable to caster relative to the frame 106 when the steering block 138 is disengaged from the front wheel steering linkage pulley 118 because the front wheel steering linkage pulley 118 is independently movable relative to the front wheel shaft 604, the steering block 340 138, the steering block track 606, and the front wheel 114. However, when the caster linkage 136 is pulled and the steering block 138 engages the front wheel steering linkage pulley 118, the front wheel 114 is steerable using the steering linkage 116 because the rotational force applied to the front wheel steering linkage pulley 118 is transferred through the steering block 138 and the steering block track 606 to the front wheel 114. In one particular 345 embodiment, the steering linkage 116 is coupled to the front wheel steering linkage pulley 118 to prevent slippage. Release of the caster linkage 136 disengages the steering block 138 from the front wheel steering linkage pulley 118 and again permits the front wheel 114 to caster relative to the frame 106.

In various embodiments, system 600 is limited to only caster mode or only 350 steering mode. Accordingly, the front wheel 114 can be rotatably coupled to the frame 106 without any additional steering mechanisms. Alternatively, the steering block 138 can be fixedly coupled to the front wheel steering linkage pulley 118. In a further embodiment, the steering block 138 is oppositely tension biased and engaged with the front wheel steering linkage pulley 118. In this embodiment, pulling of the caster linkage 136 operates to 355 disengage the steering block 138 from the front wheel steering linkage pulley 118. In one particular embodiment, the caster linkage 136 is omitted, supplemented, or replaced with an alternative mechanism for displacing the steering block 138 such as a manual lock or pin device. In a further embodiment, the front wheel 114 is coupled to the steering block track 606.

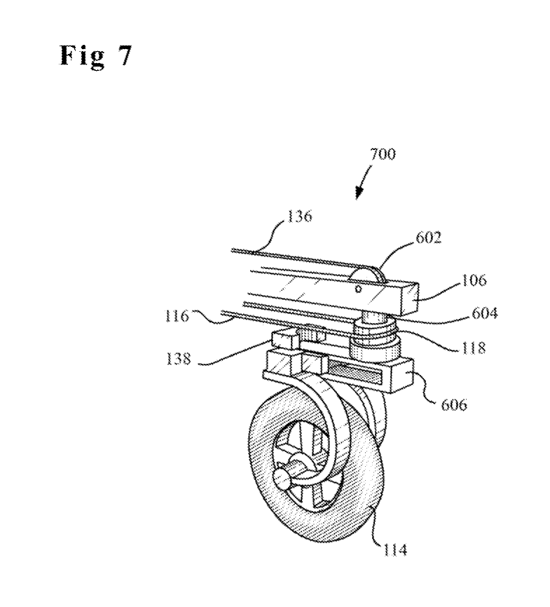

FIG. 7 is a perspective view of a dual mode front wheel system of an ergonomical multi-speed wheelchair, in accordance with an embodiment of the invention. In one embodiment, system 700 includes the frame 106, the front wheel 114, the steering linkage 116, the front wheel steering linkage pulley 118, the caster linkage 136, the steering block 138, a caster linkage pulley 602, the front wheel shaft 604, and the steering block track 365 606. The front wheel 114 is configurable to caster relative to the frame 106 when the steering block 138 is disengaged from the front wheel steering linkage pulley 118 because the front wheel steering linkage pulley 118 is independently movable relative to the front wheel shaft 604, the steering block 138, the steering block track 606, and the front wheel 114. However, when the caster linkage 136 is pulled and the steering block 138 engages the 370 front wheel steering linkage pulley 118, the front wheel 114 is steerable using the steering linkage 116 because the rotational force applied to the front wheel steering linkage pulley 118 is transferred through the steering block 138 and the steering block track 606 to the front wheel 114. Release of the caster linkage 136 disengages the steering block 138 from the front wheel steering linkage pulley 118 and again permits the front wheel 114 to caster 375 relative to the frame 106.

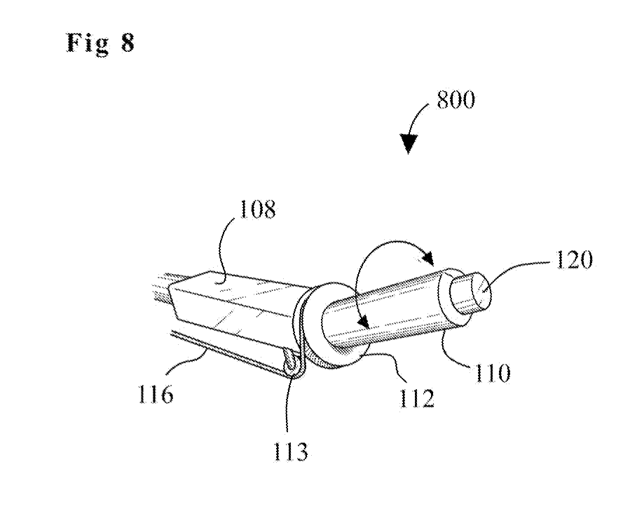

FIG. 8 is a perspective view of a handle steering system of an ergonomical multi-speed wheelchair, in accordance with an embodiment of the invention. In one embodiment, system 800 includes the drive bar 108, the handle 110, the handle pulley 112, the drive bar steering linkage pulley 113, the steering linkage 116, and the brake 120. 380 The handle 110 is rotatably coupled to the drive bar 108. The steering linkage 116 loops around the drive bar steering linkage pulley 113 and the handle pulley 112 before extending to and looping around the front wheel steering linkage pulley 118 (FIG. 1). Accordingly, rotational motion of the handle 110 is transferred into rotational motion of the front wheel steering linkage pulley 118 through the steering linkage 116. When the steering block 138 is 385 disengaged from the front wheel steering linkage pulley 118, the front wheel 114 is casterable relative to the frame 106 (FIGS. 6, 7). However, when the caster linkage 136 is pulled and the steering block 138 engages the front wheel steering linkage pulley 118, the front wheel 114 is steerable by rotating the handle 110 because the rotational force applied to the front wheel steering linkage pulley 118 through the steering linkage 116 is transferred 390 through the steering block 138 and the steering block track 606 to the front wheel 114 (FIGS. 6, 7). The brake 120 is coupled to a brake linkage 125 which operates the brake clasp 123 (FIG. 1). The brake clasp 123 is disposed proximate to the speed regulating linkage 122 and is configurable to compress against the speed regulating linkage 122 upon application of the brake 120. Compression of the brake clasp 123 against the speed 395 regulating linkage 122 induces friction and slows the speed regulating linkage 122 and the rear wheel 109 to reduce the speed of the frame 106.

While preferred and alternate embodiments of the invention have been illustrated and described, as noted above, many changes can be made without departing from the spirit and scope of the invention. Accordingly, the scope of the invention is not limited 400 by the disclosure of these preferred and alternate embodiments. Instead, the invention should be determined entirely by reference to the claims that follow.

What is claimed is:

1. A vehicle for providing ergonomical operation, the vehicle comprising:
a frame, the frame having a rear wheel and a front wheel, the rear wheel being rotationally coupled to the frame via a rear wheel shaft, the frame including a drive linkage pulley;
a drive bar, the drive bar being slidably mounted to the frame;
a slotted reel, the slotted reel mounted on the rear wheel shaft; and
a drive linkage, the drive linkage mounted to the drive bar, the drive linkage looping over
the drive linkage pulley before being coupled to the slotted reel,
wherein sliding the drive bar towards the drive linkage pulley results in the drive linkage coiling around the slotted reel, wherein sliding the drive bar away from the drive linkage pulley results in the drive linkage uncoiling from the slotted reel, and wherein uncoiling of the drive linkage operates to rotate the rear wheel shaft and the rear wheel to propel the frame.

2. The vehicle of claim 1, further comprising:
a speed regulating linkage pulley, the speed regulating linkage pulley being rotatably mounted to the frame;
a speed regulating linkage, the speed regulating linkage rotatably extending around the speed regulating linkage pulley and the rear wheel; and
a brake, the brake being disposed on the drive bar, the brake operable to control a brake clasp, the brake clasp being disposed proximate to the speed regulating linkage and configurable to induce friction on the speed regulating linkage to reduce the rear wheel speed.

3. The vehicle of claim 1, further comprising:
a plurality of slotted reels, the plurality of slotted reels being mounted on the rear wheel shaft, at least some of the plurality of slotted reels having a different diameter, wherein the drive linkage is coupled to and movable among the plurality of slotted reels to provide different gears.

4. The vehicle of claim 3, further comprising:
a centrifugal weight, the centrifugal weight slidably mounted on the rear wheel;
a centrifugal linkage, the centrifugal linkage being coupled to the centrifugal weight, the centrifugal linkage extending within the rear wheel shaft; and
rotational magnets, the drive linkage and the centrifugal linkage being magnetically coupled through the rotational magnets, the rotational magnets configurable to permitting the centrifugal linkage to rotate relative to the drive linkage, the rotational magnets configurable to forcing the drive linkage to trace lateral displacement of the centrifugal linkage,
wherein the centrifugal weight is configurable to aligning the drive linkage with a different slotted reel upon rotation of the rear wheel.

5. The vehicle of claim 1, further comprising:
a handle, the handle being rotatably coupled to the drive bar, the handle including a handle pulley;
a front wheel steering linkage pulley, the front wheel steering linkage pulley being coupled to the front wheel; and
a steering linkage, the steering linkage looping over the handle pulley and the front wheel steering linkage pulley,
wherein rotation of the handle is configurable to rotate the front wheel steering linkage pulley and the front wheel through the steering linkage.

6. The vehicle of claim 5 wherein the front wheel includes a steering block, wherein the steering block is removably engageable with the front wheel steering linkage pulley, and wherein disengagement of the steering block from the front wheel steering linkage pulley is configurable to permit the front wheel to caster relative to the frame.

7. The vehicle of claim 6 wherein the steering block is tension biased to being disengaged from the front wheel steering linkage pulley, wherein a caster linkage is coupled to the steering block, and wherein displacement of the caster linkage is configurable to engage the steering block with the front wheel steering linkage pulley.

8. A gear system for use on a vehicle for providing ergonomical operation, the gear system comprising:
a first slotted reel;
a drive linkage, the drive linkage configurable to extend through the slot of the first slotted reel, the drive linkage configurable to uncoilably coil around of the first slotted reel,
wherein the gear system is configurable to being coupled to a wheel, wherein the drive linkage is configurable to being coupled to a drive bar, and wherein displacement of the drive bar is configurable to uncoilably coil the drive linkage around the first slotted reel to rotate the wheel.

9. The gear system of claim 8, further comprising:
at least one additional slotted reel, the at least one additional slotted reel disposed adjacent to the first slotted reel, the at least one additional slotted reel having a different diameter than the first slotted reel, the slots of the first slotted reel and the second slotted reel being at least partially aligned,
wherein the drive linkage is configurable to extend through the at least partially aligned slots of the first slotted reel and the second slotted reel, wherein the drive linkage is configurable to uncoilably coil around any of the first slotted reel and the at least one additional slotted reel, wherein the drive linkage configurable to slidably move between alignment with the first slotted reel and the at least one additional slotted reel, and wherein displacement of the drive bar is configurable to uncoilably coil the drive linkage around any of the first slotted reel and the at least one additional slotted reel to rotate the wheel.

10. The gear system of claim 9, further comprising:
a centrifugal linkage;
rotational magnets, the drive linkage and the centrifugal linkage being magnetically coupled through the rotational magnets, the rotational magnets configurable to permitting the centrifugal linkage to rotate relative to the drive linkage, the rotational magnets configurable to forcing the drive linkage to trace the lateral displacement of the centrifugal linkage,
wherein the centrifugal linkage is configurable to being coupled to a centrifugal weight that is slidably disposed on the wheel and wherein the centrifugal weight is configurable to aligning the drive linkage with any of the first slotted reel and the at least one additional slotted reel upon rotation of the rear wheel.

11. A steering system for use on a vehicle for providing ergonomical operation, the steering system comprising:
a handle, the handle including a handle pulley;
a wheel steering linkage pulley;
a steering linkage, the steering linkage looping over the handle pulley and the wheel steering linkage pulley,
wherein the handle is configurable to being rotated, wherein the wheel steering linkage pulley is configurable to being coupled to a wheel, and wherein rotation of the handle is configurable to rotate the wheel steering linkage pulley and the wheel through the steering linkage.

12. The steering system of claim 11 wherein the wheel is configurable to include a steering block, wherein the steering block is configurable to removably engage with the wheel steering linkage pulley, and wherein disengagement of the steering block from the wheel steering linkage pulley is configurable to permit the wheel to caster independently of the handle rotation.

13. The steering system of claim 12 wherein the steering block is configurable to being tension biased to being disengaged from the wheel steering linkage pulley, wherein a caster linkage is configurable to being coupled to the steering block, and wherein displacement of the caster linkage is configurable to engage the steering block with the wheel steering linkage pulley.

14. A vehicle for providing ergonomical operation, the vehicle comprising:
a frame, the frame including at least one wheel and a drive bar; and
a means for rotating the wheel by moving the drive bar in an approximately vertical motion.

15. The vehicle of claim 14, further comprising:
a means for reducing the speed of the wheel using a control on the drive bar.

16. The vehicle of claim 14, further comprising:
a means for providing different gears for rotating the wheel by moving the drive bar in an approximately vertical motion.

17. The vehicle of claim 16, further comprising:
a means for automatically shifting gears based upon rotational speed of the at least one wheel.

18. The vehicle of claim 14, further comprising:
a means for turning the frame relative to the ground using a control on the drive bar.

19. The vehicle of claim 18, further comprising:
a means for optionally permitting the frame to caster relative to the ground.
